(19) United States
(12) Patent Application Publication
(10) Pub. No.: US 2021/0244008 A1
(43) Pub. Date: Aug. 12, 2021

(54) Bait Drive Unit and Bait Fish having a Bait Drive Unit

(71) Applicant: Olivier Portrat, Saarbrucken (DE)

(72) Inventor: Olivier Portrat, Saarbrucken (DE)

(21) Appl. No.: 17/221,149

(22) Filed: Apr. 2, 2021

Related U.S. Application Data
(62) Division of application No. 15/772,053, filed on Apr. 28, 2018.

(30) Foreign Application Priority Data
Jan. 8, 2016 (DE) 10 2016 114 223.9

(51) Int. Cl. A01K 85/16; A01K 85/01; A01K 97/04

(52) U.S. Cl. CPC A01K 85/16; A01K 97/04; A01K 85/01

(57) ABSTRACT

The invention relates to a bait drive unit (1), in particular to be installed in a bait fish (100, 110), and to a bait fish (100, 110) having a bait drive unit (1). The object of the invention is to provide a bait drive unit (1) which, situated in a bait fish (100, 110), imitates even more effectively the movements of a “sick” bait fish (100, 110) and thus promises an even higher yield when fishing. A further object of the invention is to provide a bait fish (100, 110) having such a bait drive unit (1). The object is achieved, inter alia, by a bait drive unit (1), in particular to be installed in a bait fish (100, 110), having an energy store (2), an electromotive drive device (3) and a shaft actuatable via the electromotive drive device (3), in that the shaft (4) is curved in such a way that, when projecting into a plane, the curvature of the shaft (4) does not undergo any change in the sign.

The present invention relates to a bait drive unit, in particular for installation in a bait fish, and to a bait fish having a bait drive unit.

The best bait for predator fishing is live bait fish. This is because, when attached to the hook, the bait fish is restricted in its movements. This restriction of movement makes the bait fish look sick and weakened, which gives predators an incentive to take the prey with little effort.

However, for ethical and animal welfare reasons, the live bait fish is or will be banned in more and more countries. In addition, live bait fish are not always and everywhere available.

For this reason, artificial baits in fish shape have been developed in various embodiments, for example as a wobbles, blinker or pirk.

These artificial baits already play an important role in fishing for predatory fish. Artificial baits are designed to mimic the movement of a fish as it is pulled through the water. The pulling through the water is achieved by reeling in the fishing line; in most cases this is achieved using the reel located at the fishing rod. Only by this reeling-in, pressure is exerted onto a diving lip (wobbler), onto a metal blade (spinner) or the like, as a result of which the artificial bait is moved into lateral or rotating movements. A disadvantage for all artificial baits is however that they have to be reeled in by the fisherman, which in turn results in that the artificial baits do not remain with the predatory fish but are pulled away from them. However, if the bait moves away from the predatory fish, it limits the appeal for catching, as such an artificial bait then does not appear weakened to the predator. If a predatory fish wanted to hunt the artificial bait, he would have to take up the pursuit. It is further hampering that the movements performed by the artificial baits are not sufficiently true to nature, that is, the typical fidgety and irregular movements of a sick or injured fish cannot be simulated. Especially when fishing for bigger predatory fish, the detection capability of which may be very high, it is difficult to outwit the predatory fish by the mentioned artificial bait.

In order to achieve that the artificial baits can remain in a desired area and, for this reason, do not have to be moved by the fisherman by pull artificial bait fish have been developed, which have an actuator setting the artificial bait fish into motion.

For example, DE 197 22 368 A1 discloses an artificial bait fish having a movable caudal fin connected to the bait fish body, the caudal fin being moved back and forth via two puffing elements, which are pulled back in an alternating manner by an actuator.

DE 39 21 156 A1 discloses an artificial bait having a drive, by which a propulsion is generated with the aid of a rotating fin and/or a propeller.

DE 202 01 645 U1 discloses a bait, which is made up of sections which are movable in relation to one another or are elastic. The bait is provided with a motor, via which the sections relative to one another can be set into motion. The motor can either affect a rotary movement of the body about an axle, set the body into vibration by weights situated eccentrically on the axle or rotate a spiral about the axle so to twist the body of the bait.

### SUMMARY OF THE INVENTION

It is the object of the present invention to provide a bait drive unit which, disposed in a bait fish, even more effectively imitates the movement of a “sick” bait fish and, for this reason, promises a higher yield when fishing. Furthermore, it is the object of the present invention to provide a bait fish having such a bait drive unit.

The object is achieved by a bait drive unit, in particular for installation in a bait fish, having an energy storage device, an electromotive drive device and a shaft which can be actuated via the electromotive drive device in such a way that there is no change in the curvature of the shaft when during operation.

The electromotive drive device supplied with power by the energy storage device may be a motor, for example a direct current motor, for continuously rotating the shaft in one direction or be a motor actuatable in the direction of rotation for reversing the direction of rotation of the shaft first in one direction and then in the opposite direction.

In the most simple case, the energy storage device may be a battery. Likewise, the energy storage device may be a rechargeable battery pack.

The electromotive drive device rotates the shaft about an axis of rotation. Within the context of this invention, this axis of rotation is defined so that the axis of rotation extends as a straight line in the drive direction of the drive device. The orientation of the shaft conforms with the orientation of the axis of rotation in the region in which the shaft is attached to the drive device. During further course, the shaft is curved.

The shaft is configured in such a manner that the end facing away from the electromotive drive device is radially spaced apart from the (virtually extended) axis of rotation.

So that the end of the shaft can be spaced radially apart from the axis of rotation, it is for example provided that the shaft starting from the electromotive drive device features a curvature.

The curvature of the shaft is configured in such a manner that it, starting from the electromotive drive device, does not undergo a change in direction of the curvature during operation. For example, this may be carried out in a region of the shaft facing away from the motorized drive device by a curvature to the right or by a curvature to the left of the shaft (if the curvature is carried out in a plane). Thus, the end of the shaft facing away from the electromotive drive device is radially spaced apart from the (virtually extended) axis of rotation.

Likewise, the shaft may also be curved three-dimensionally (3D), in that the shaft in combination with the curvature to the left or to the right undergoes a curvature upwards or downwards out of the plane. This curvature is also carried out in such a manner—that is, in a limited manner—so that this curvature when the shaft does not change when it projects into a plane—for example, the horizontal plane. A projection of the shaft into a plane can, for example, correspond with the projection of a quarter circle of a spiral.

Likewise, the shaft may also be curved three-dimensionally (3D), in that the shaft in combination with the curvature to the left or to the right undergoes a curvature upwards or downwards out of the plane. This curvature is also carried out in such a manner—that is, in a limited manner—so that this curvature when the shaft projects into a plane—for example, the horizontal plane does not undergo a change of the sign. A projection of the shaft into a plane can, for example, correspond with the projection of a quarter circle of a spiral.

In order to facilitate the introduction of a bait drive unit into a bait fish, it is advantageously provided that the curvature of the shaft is constant over the length of the shaft.

This configuration simplifies to retroactively introduce the bait drive unit into a bait fish, because the bait drive unit can be inserted into the bait fish with the end facing away from the drive unit leading. The introduction can then be carried out by a push and rotary motion.

The radius of the circular arc movement (motor actuatable in the direction of rotation for reversing the direction of rotation) or the circular movement (direct current motor for continuously rotating the shaft in one direction) of the end of the shaft facing away from the electromotive drive device about the axis of rotation depends on the degree of curvature of the shaft. In the case of a stronger curvature, the end of the shaft facing away from the electromotive drive device is further spaced apart from the axis of rotation than in the case of a weaker curvature. Accordingly, the movement of the bait drive unit having a stronger curvature is greater than the movement of the bait drive having a weaker curvature.

It is furthermore provided that the end of the shaft facing away from the electromotive drive device is configured as a tip or a mandrel so that this tip or mandrel can be slid or plugged into the tail area of an artificial bait fish or into the root of the tail of a dead bait fish. In this instance, the tip can serve as a point of suspension or as a point of support or point of fixation.

In order to prevent rotation of the bait drive unit about its own axis within the bait fish, it is furthermore provided that at least the electromotive drive device of the bait drive unit has a fastening means, for example a spike, wire or the Ike, to fix the electromotive drive device in a bait fish. It is provided that the shaft is not fixed by the fastening means. The possibility of a rotationally fixed bearing of the drive device in a bait fish and a simultaneous rotatability of the shaft results in that the shaft rotates in the bait fish. The torque occurring in this instance is supported at the part of the bait fish in which the electromotive drive device is mounted. Since this part of the bait fish has, in particular owing to the electromotive drive device, a substantially larger moment of inertia than the part of the bait fish in which the shaft is guided, it appears, viewed from the outside onto the bait fish, as if substantially only the part moves in which the shaft is guided. This course of motion corresponds comparatively realistically to the movement pattern of a fish.

Since sick fish move irregularly, the present invention furthermore includes that the bait drive unit has a control device, which generates a time-adjustable delay, interruption, tempo change or accidental on/off switching of the electromotive drive device and, thus, of the shaft rotation. Likewise, it is conceivable that the control device generates a combination of the aforementioned actions. As a result, an irregular movement or an irregular wriggling of the body is achieved, which in turn has a particularly large deception effect on the predatory fish as they perceive an injured bait fish.

In the case that the bait drive unit has a control device, it is furthermore advantageously provided that the control device has a memory element and/or a data transmission unit and/or a data reception unit. Using a memory element enables a programming of the control device, which in turn controls the electromotive drive device and, for this reason, actuates the shaft. The programs stored on the memory element can already be preprogrammed on the memory element by the manufacturer. Likewise, user-specific programs geared toward specific applications can be independently transferred to the memory element by the user via the data receiving unit. A data transmission unit during use of the bait drive unit enables to evaluate stored results to be subsequently evaluated with the aid of a data processing device (mobile phone, smartphone, tablet computer, portable computer, workstation or server computer).

As a result, a variety of application possibilities are available such as the processing of programs using their own movement patterns, the comparison of the use of individual users, the setting and exchange of user profiles, the evaluation of programs and patterns and, thus, to better address customer needs and the like.

For example, the bait drive unit may furthermore feature a force sensor which detects the bite strength of a predatory fish. Likewise, the bait drive unit may have a temperature sensor. Such data can be stored on the memory element.

Likewise, it may be also stored on the memory device that the electromotive drive device is disabled if the force sensor detects a bite of a predator fish which exceeds a preset minimum strength.

Advantageously, it is furthermore provided that the data transmission unit and/or the data reception unit is/are configured for wireless data communication.

Using this configuration, the bait drive unit can be remotely controlled by a remote data processing device. Once the functional state of the bait drive unit is such that the wireless data communication link operates, that is, responds to requests from a remote device, all functions of the bait drive unit can be remotely controlled via this wireless connection, for example also over the Internet, Also a data exchange of programs and of user data is possible.

Advantageously, the wireless data communication is designed as a Bluetooth, WLAN or NCF module or as a mobile radio module according to GPRS, 3G or LTE standard. These standards are now mature transmission systems available with most smartphones and mobile phones, providing sufficiently high data transfer rates. As a result, a wireless connection can be set up for most of the data processing devices, the transmitted data then being able to be processed directly in the data processing device.

Advantageously, the present invention further includes that the bait drive unit includes a mechanical switching element and/or a contactless switching element.

In the simplest case, the switch is set up in such a manner that it can turn on and off the electromotive drive device of the bait drive unit.

However, the switches can also be set up in such a manner that, in addition to the start-up of the bait drive unit, they can activate a plurality of functional states of the bait drive unit. A mechanical switching element could for example be a manual switch having various adjustment options, which in turn start various programs. If, for example, a magnetic switch is used as the contactless switching element, the program which is to be executed can be selected by the length of the stopping duration (start program, movement program 1, movement program 2, . . . , stop program). Likewise, the contactless switching element can be configured in such a manner that it can be put into an active operating state via a wireless data communication connection.

Advantageously, the control device, the memory element, the contactless switching element and optionally the wireless data communication connection (data transmission unit and/or the data reception unit) are disposed on one circuit board. This results in space savings, power savings and thus cost savings for the entire bait drive unit.

Since batteries or battery packs must be replaced after power output or removed for recharging, which favors, among other things, a faulty operation, an advantageous embodiment of the present invention further provides that the energy storage device is a battery pack chargeable by a charging unit, which is contactlessly rechargeable.

This embodiment prevents that battery packs are charged via electric contacts. This has advantages with regard to short circuit resistance and the corrosion of any electrical contacts. The contactless charging enables that the battery pack can be wrapped in a waterproof manner. The contactless charging can be carried out by known methods and devices which are already used, for example, in the mobile communication industry, both by inductive and by capacitive energy transfer.

Since light on a bait attracts the attention of predatory fish, the present invention furthermore advantageously provides that the bait drive unit has at least one light source configured as a light emitting diode or LED.

The light source can be connected to the energy storage device via cables. The cable connection may guide the light from the light source to the desired lighting area (z. B. the eyes of a bait fish). Likewise, it is conceivable that a light pattern program controls the on and off switching or dimming of the light source via the control device. The light source can also be arranged on the circuit board described above. Alternatively, the light from the light source can be guided via a light conductor, for example a glass fiber or POP (polymer optical fiber), to the desired lighting area (z. B. the eyes of a bait fish).

The present invention furthermore includes that at least one energy storage device and the electromotive drive device are disposed in a shell which is watertight or impervious to fluids. The shell may be made from plastic material, plexiglass, glass, metal or the like. In the case that the shell is made from plastic material, it may be elastic, thereto-elastic (for example, a heat shrink tube) or inelastic. Furthermore, the shell may be transparent or be partially opaque or opaque by color pigment addition.

It is important that at least the energy storage device and the electromotive drive device are protected by the shell from contact with water. Advantageously, it is provided for this purpose that the energy storage device and the electromotive drive device are mounted in a rotatably fixed manner in the shell. The rotatably mounted shaft may be connected to the drive device in such a manner that no water reaches the drive device or the energy storage device. The shaft can be stored comparable to the bearing of the shaft of a ship propeller, which is led out of the hull via a stuffing box. The shaft is sealed via the stuffing box, but is still rotatable.

This embodiment of the present invention enables that the bait drive unit can be installed in a dead fish without causing short circuits or corrosion.

Furthermore, it is conceivable that all components sensitive to water are situated in the shell. All components sensitive to water are then safely protected in the shell.

It is also conceivable that the shaft is also situated in the shell. For this purpose, it is however provided that the shell at least in the region of the curvature of the shaft is made from elastic material. In this embodiment, the shaft can be actuated without further precautionary measures against water ingress into the drive device.

If the shell is fixedly connected to the shaft over the entire length of the shaft, it is provided that the electromotive drive device is a motor actuatable in the direction of rotation for reversing the direction of rotation of the shaft first in one direction (for example +120°) and then in the opposite direction (for example) −120°). In this case, the rotation is to be designed in such a manner that the elastic limit of the shell is not exceeded and the shell does not tear off. For reversing the direction of rotation, it is provided that the motor actuatable in the direction of rotation for reversing the direction of rotation of the shaft first rotates by a predefined degree in one direction (for example, up to optionally +180°, preferably up to +90°, particularly preferably between +30° and +45°) and then rotates by the same degree in the opposite direction (for example up to optionally −180°, preferably up to −90°, particularly preferably between −30° and −45°).

It is also conceivable that the shaft is movably disposed in the shell. Since the shell in the region of the shaft is elastic and the shaft can rotate in the shell, the electromotive drive device can be a motor, for example a direct current motor, which enables a continuous rotation of the shaft in one direction. In this embodiment, the shaft is rotatable in the shell. This means that the shell is not wound up when the shaft rotates.

One embodiment of the present invention furthermore provides that a drying cartridge is also disposed in the watertight or liquid-resistant shell, which possibly absorbs existing residual moisture or penetrating moisture. This protects the bait drive unit from corrosion and failure.

A further embodiment of the present invention provides that a catalyst cartridge is disposed in the watertight or liquid-resistant shell, which receives hydrogen resulting from charging and discharging of battery packs, and which converts the hydrogen. This prevents the formation of oxyhydrogen gas.

The object of the present invention is also achieved by a bait fish having the described bait drive unit in that the electromotive drive device is mounted in a rotatably fixed manner in the body of the bait fish and in that the body of the bait fish, at least in the region in which the actuatable shaft is guided by the electromotive drive device in the bait fish, is made of an elastic material, the elastic material having a greater bending elasticity than the shaft, and the actuatable shaft is guided in the bait fish in such a manner that a movement of the shaft guided in the bait fish is transferred to the elastic material.

According to the present invention, the bait fish can be an artificial bait fish or a dead fish. If the bait fish is an artificial bait fish, it is provided that the body of the artificial bait fish, at least in the region in which the shaft connected to the electromotive drive device is situated, is made from elastic material. All materials which can follow the movement of the shaft without tearing can be used as elastic materials. According to the present invention, in particular rubber, plastic, in particular soft plastic, silicone, latex or the like are provided as material. Furthermore, it is provided for the artificial bait fish that at least the electromotive drive device is mounted in a rotatably fixed manner in the body. This can be carried out, for example, in that the electromotive drive device is cast into a fish body made of plastic.

The degree of required elasticity of the bait fish on the one hand is a function of the bending strength of the shaft, of the drive torque of the electromotive drive device and of the material thickness of the bait fish in the region to be deformed.

If the shaft is also cast in and if the shaft and the elastic material are fixedly connected at their ends, it is provided that the electromotive drive device, a motor actuatable in the direction of rotation for reversing the direction of rotation of the shaft, is first rotated by a predefined degree in one direction (for example, up to optionally +180°, preferably up to +90°, particularly preferably between +30° and +45°) and then is rotated by the same degree in the opposite direction (for example up to optionally −180°, preferably up to −90°, particularly preferably between −30° and −45°).

It can be provided that the shaft connected to the electromotive drive device and the watertight shell is rotatably guided in a duct of the elastic body. For example, the duct can be formed by pulling on the elastic material after casting, so that the elastic material breaks off from the shaft. Likewise, it is conceivable that the duct is formed by inserting or pressing the shaft into the elastic body. In particular, inserting the shaft into a bait fish has the advantage that the fisherman by himself/herself can insert the bait drive unit into a bait fish. This may be necessary if a bait fish has been destroyed or—in the case of a dead fish—has spoiled. The bait drive unit can be reused.

If the shaft is already movably disposed in a watertight shell, the electromotive drive device can be a motor, for example a direct current motor, which enables a continuous rotation of the shaft in one direction. Since the shell is elastic in the area of the shaft and the shaft can rotate in the shell, and since the body of the artificial bait fish, at least in the region in which the shaft connected to the electromotive drive device is situated, is made of elastic material, a tearing of the shell and the body is prevented. Upon rotation of the shaft, the bending of the bait fish follows, because of its elasticity in the region in which the shaft is mounted, the bending of the shaft according to the current angle position of the shaft. Since the shaft at its exterior surface is not connected to the shell or the duct, the bait fish in this instance is not wound up.

The bait fish may also be a dead fish in which the bait drive unit is situated or can be situated.

Leading by the shaft end, the bait drive unit can be inserted, for example through the mouth of the dead fish or through a cut in the head area, in the dead but elastic body.

The object of the present invention is achieved also by a bait fish having the previously described bait drive unit, in which the shaft is curved in such a manner that, when projecting into a plane, the curvature of the shaft does not undergo a change in direction, and in that the electromotive drive device is mounted in a rotatably fixed manner in the body of the bait fish and in that the body of the bait fish at least in the region in which the actuatable shaft is guided by the electromotive drive device in the bait fish, is made of an elastic material, the elastic material having a greater bending elasticity than the shaft, and the actuatable shaft is guided in the bait fish in such a manner that a movement of the shaft guided in the bait fish is transferred to the elastic material, and that the shaft in the region of the curvature has a molding and the elastic body has a recess for the molding.

The molding may be formed as an eccentrically situated weight, which is disposed in the region of the curvature of the shaft. Likewise, the molding can be formed in the region of the curvature by the shaft itself. For example, the shaft may have a substantially U-shaped area which acts like the eccentrically situated weight. The eccentrically situated weight or the U-shaped area may have a roller body, which enables that the molding can be guided along at least one of the inner walls of the recess (without major friction losses). Because the shaft is rotated by the electromotive drive device about the axis of rotation, the molding is also rotated about the axis of rotation.

The recess is preferably a recess running radially around the axis of rotation of the shaft, which is disposed in the region of the elastic body of the bait fish. The recess can be configured in such a manner that the molding can rotate contactlessly within the recess. Likewise, it is provided that the recess is designed in such a manner that the movement of the rotating molding is transferred to the elastic material.

Since the body in the region of the shaft is elastic and the elastic body in the region of the molding has a recess preferably radially extending around the axis of rotation, in which the molding can rotate in a contactless manner or by having contact with the recess, the electromotive drive device can be a motor, for example a direct current motor, which enables a continuous rotation of the shaft in one direction.

The degree of required elasticity of the bait fish on the one hand is a function of the bending strength of the shaft, of the drive torque of the electromotive drive device and of the material thickness of the bait fish in the region to be deformed.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 shows a schematic cross section of a bait drive unit having an energy storage device, an electromotive drive device and a curved shaft actuatable via the electromotive drive device;

FIG. 2 shows a schematic cross section of a bait drive unit having an energy storage device, an electromotive drive device, a curved shaft actuatable via the electromotive drive device and a control device;

FIG. 3 shows a schematic cross section of a bait drive unit having an energy storage device, an electromotive drive device, a curved shaft actuatable via the electromotive drive device, a control device and a shell, which encloses the previously mentioned components in a waterproof manner;

FIG. 4 shows a schematic cross section of a bait fish having a bait drive unit, the bait drive unit having an actuated curved shaft;

FIG. 5 shows a schematic cross section of the bait fish having a bait drive unit from FIG. 4, the actuated curved shaft being rotated by approximately 90°;

FIG. 6 shows a schematic cross section of the bait fish having a bait drive unit from FIG. 5, the actuated curved shaft being further rotated by approximately 90°;

FIG. 7 shows a schematic cross section of the bait fish having a bait drive unit from FIG. 6, the actuated curved shaft being further rotated by approximately 90°; and

FIG. 8 shows a schematic cross section of the bait fish having a bait drive unit, which has a molding and the elastic body of the bait fish having a recess for the molding.

### DESCRIPTION OF THE PREFERRED EMBODIMENTS

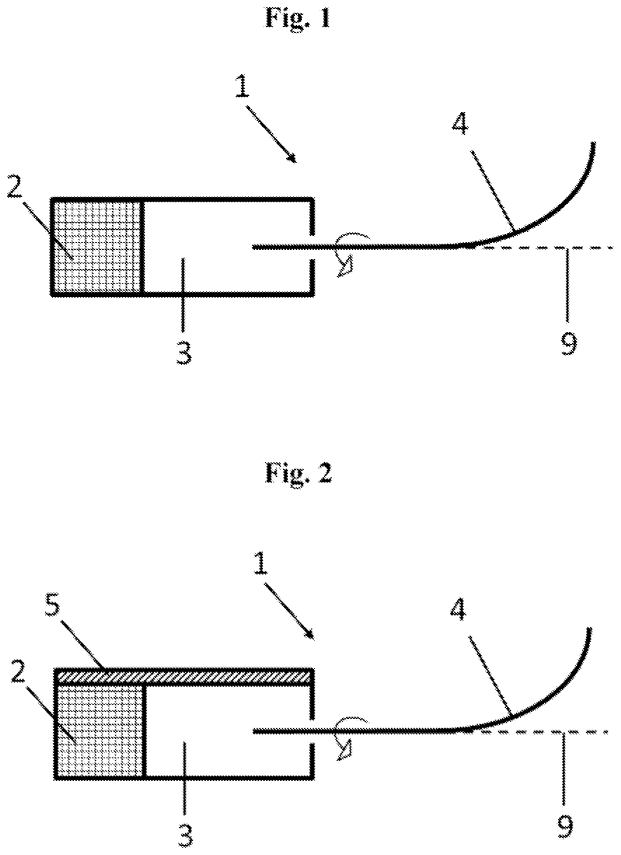

FIG. 1 shows a bait drive unit (1), in particular for installation in a bait fish, having an energy storage device (2), an electromotive drive device (3) and a shaft (4) actuatable via the electromotive drive device (3). The energy storage device (2) may be a battery or a rechargeable battery pack. The electromotive drive device (3) supplied with power by the energy storage device (2) may be a motor, for example a direct current motor, for continuously rotating the shaft (4) in one direction or be a motor actuatable in the direction of rotation for reversing the direction of rotation of the shaft (4) first in one direction and then in the opposite direction. The shaft (4) rotates—as shown (see rotation arrow)—with the aid of the drive of the electromotive drive device radially about the axis of rotation (9) (for a continuous rotation in one direction) or rotates back and forth (in case of a motor actuatable in the direction of rotation for reversing the direction of rotation of the shaft). The axis of rotation (9) is illustrated as a straight line in drive direction from the drive device (3). The orientation of the shaft (4) in this instance conforms with the orientation of the axis of rotation (9) in the region in which the shaft (4) is attached to the drive device (3). As shown, the shaft is curved in such a manner that, when projecting into a plane (for example shown by the sectional views of FIGS. 1 through 7), the curvature of the shaft (4) does not undergo a change direction. In the shown example, the curvature of the shaft (4) is constant. This configuration simplifies to retroactively introduce the bait drive unit (1) into a bait fish, because the bait drive unit can be inserted into the bait fish leading by the end facing away from the drive unit (2). The introduction can then be carried out by a push and rotary motion.

FIG. 2 shows the bait drive unit (1) from FIG. 1, the bait drive unit (1) having a control device (5), which can generate a time-adjustable delay, interruption, tempo change or accidental on/off switching of the electromotive drive device (3) and, thus, of the shaft rotation. The insertion of the bait drive unit (1) having the control device (5) into a bait fish results in that an irregular wriggling of the body of the bait fish is achieved, which in turn has a particularly large deception effect on the predatory fish as they perceive an injured bait fish.

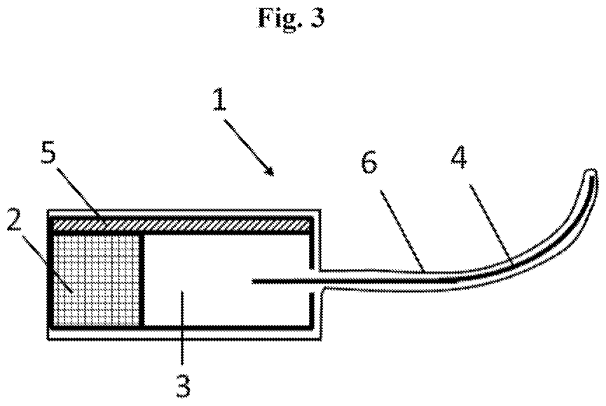

FIG. 3 shows the bait drive unit (1) from FIG. 2, the energy storage device (2), the electromotive drive device (3), the control device (5) as well as the shaft (4) being disposed in a shell (6) which is watertight or resistant to water. The shell (6) at least in the region of the curvature of the shaft (4) is made from an elastic material. This shown embodiment makes it possible that the bait drive unit (1) can be installed in a dead fish without causing short circuits or corrosion.

If the shell is fixedly connected to the shaft over the entire length of the shaft, it is provided that the electromotive drive device (3) is a motor actuatable in the direction of rotation for reversing the direction of rotation of the shaft (4) first in one direction (for example +120°) and then in the opposite direction (for example −120°). In this case, the rotation is to be configured in such a manner that the elastic limit of the shell is not exceeded and the shell does not tear off. For reversing the direction of rotation, it is provided that the motor actuatable in the direction of rotation for reversing the direction of rotation of the shaft first rotates by a predefined degree in one direction (for example, up to optionally +180°, preferably up to +90°, particularly preferably between +30° and +45°) and then rotates by the same degree in the opposite direction (for example up to optionally −180°, preferably up to −90°, particularly preferably between −30° and −45°).

Likewise, the shaft (4) can be movably disposed in the shell (6). Since the shell (6) in the region of the shaft (4) is elastic and the shaft (4) can rotate in the shell (6), the electromotive drive device (3) can be a motor, for example a direct current motor, which enables a continuous rotation of the shaft (4) in one direction. In the last embodiment, the shaft (4) is rotatable in the shell (6). This means that the shell (6) is not wound up when the shaft (4) rotates.

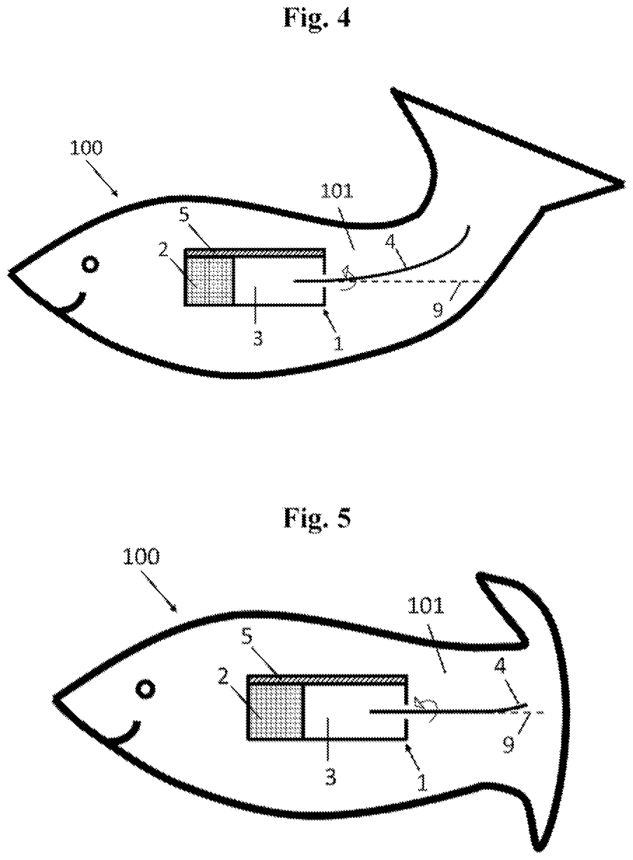

FIGS. 4 through 7 show a section of a bait fish (100), having a bait drive unit (1), in different rotational positions of the shaft (4). The body (101) of the dead or artificial bait fish (100) at least in the region in which the shaft (4) actuatable by the electromotive drive device (3) is guided in the bait fish (100), is made of an elastic material. The elastic material has a greater bending elasticity than the shaft (4). As shown in FIGS. 4 through 7, the actuatable shaft (4) is guided in the bait fish (100) in such a manner that a movement of the shaft (4) guided in the bait fish (100) is transferred to the body (101) of the bait fish (100). In FIG. 4, the end of the shaft (4) facing away from the drive device (3) points upwards.

In FIG. 5, the end of the shaft (4) facing away from the motorized drive device (3) points backwards out of the plane of the drawing. Accordingly, the shaft has been rotated by approximately 90°.

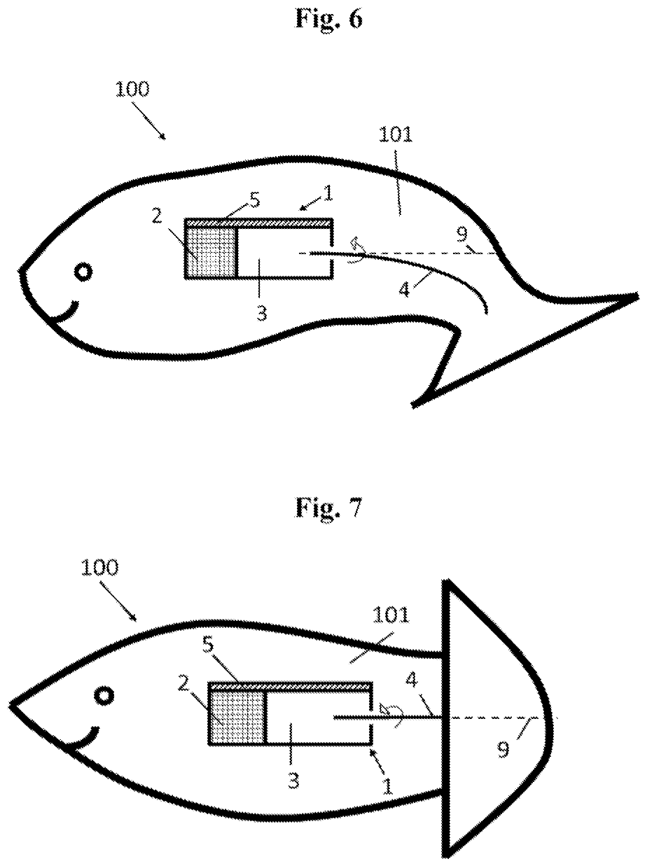

In FIG. 6, the end of the shaft (4) facing away from the motorized drive device (3) points downwards. Accordingly, the shaft vis-à-vis the illustration in FIG. 5 has been rotated by approximately a further 90°.

In FIG. 7, the end of the shaft (4) facing away from the motorized drive device (3) points forward out of the plane of the drawing. Accordingly, the shaft vis-à-vis the illustration in FIG. 6 has been rotated by approximately a further 90°.

The electromotive drive device (3) is mounted in a rotationally fixed manner in the body (101) of the bait fish (100). The rotationally fixed bearing of the drive device (3) in the bait fish and a simultaneous rotatability of the shaft (4) result in that the shaft (4) rotates in the bait fish. The torque occurring in this instance is supported at the part of the bait fish (100) in which the electromotive drive device (3) is mounted. Since this part of the bait fish (100) has, in particular owing to the electromotive drive device (3), a substantially larger moment of inertia than the part of the bait fish (100) in which the shaft (4) is guided, it appears, viewed from the outside onto the bait fish (100), as if substantially only the part moves in which the shaft (4) is guided. This course of motion corresponds comparatively realistically to the movement pattern of a wriggling fish.

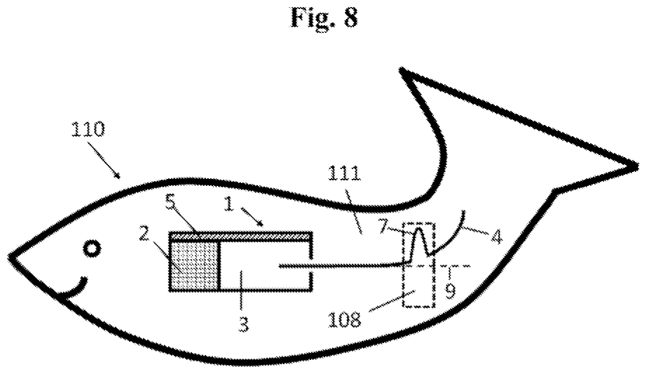

FIG. 8 shows a section of a bait fish (110) having a bait drive unit (1) including a shaft (4), which in the region of the curvature has a molding (7). The body (111) of the dead or artificial bait fish (110), at least in the region in which the shaft (4) actuatable by the electromotive drive device (3) is guided in the bait fish (110), is made of an elastic material. The elastic material has a greater bending elasticity than the shaft (4).

Moreover, the elastic body has a recess (108) running radially about the axis of rotation, in which the molding (7) of the shaft (4) of the bait drive unit (1) can rotate in a contactless manner.

The electromotive drive device (3) is mounted in a rotationally fixed manner in the body (111) of the bait fish (110). The rotationally fixed bearing of the drive device (3) in the bait fish and a simultaneous rotatability of the shaft (4) results in that the shaft (4) rotates in the bait fish. The torque occurring in this instance is supported at the part of the bait fish (110) in which the electromotive drive device (3) is mounted. Since this part of the bait fish (110) has, in particular owing to the electromotive drive device (3), a substantially larger moment of inertia than the part of the bait fish (110) in which the shaft (4) is guided, it appears, viewed from the outside onto the bait fish (110), as if substantially only the part moves in which the shaft (4) is guided. This course of motion corresponds comparatively realistically to the movement pattern of a wriggling fish.

What is claimed is:

1. A bait drive unit (1), in particular for installation in a bait fish, comprising:
an energy storage device (2);
an electromotive drive device;
a shaft (4) actuatable via the electromotive drive device (3), characterized in that the shaft (4) is curved in such a manner that when projecting into a plane, a curvature of the shaft (4) does not undergo a change of direction; and
a shell (6) forming a channel circumscribing at least the shaft in such a way that a shape of the channel and a shape of the shaft correspond to each other;
wherein the shaft being of a harder material than the shell such that the shape of the channel follows the shaft during rotation.

2. The bait drive unit (1) as recited in claim 1 characterized in that the bait drive unit (1) has a control device (5).

3. The bait drive unit (1) as recited in claim 2, characterized in that the control device (5) has a memory element and/or a data transmission unit and/or a data reception unit.

4. The bait drive unit (1) as recited in claim 3, characterized in that the data transmission unit and/or the data reception unit is/are configured for wireless data communication.

5. The bait drive unit (1) as recited in one of claims 1 through 4, characterized in that the bait drive unit (1) has a mechanical switching element and/or a contactless switching element.

6. The bait drive unit (1) as recited in claim 1 characterized in that the energy storage device (2) is a battery pack chargeable by a charging unit, which is chargeable in a contactless manner.

7. The bait drive unit (1) as recited in claim 1, characterized in that the bait drive unit (1) has at least one light source configured as a light emitting diode or LED.

8. The bait drive unit (1) as recited in one of the preceding claims 1, characterized in that at least the energy storage device (2) and the electromotive drive device (3) are disposed in the watertight shell (6).

9. The bait drive unit (1) as recited in one of the preceding claims 2, characterized in that at least the energy storage device (2) and the electromotive drive device (3) are disposed in the watertight shell (6).

10. The bait drive unit (1) as recited in one of the preceding claims 3, characterized in that at least the energy storage device (2) and the electromotive drive device (3) are disposed in the watertight shell (6).

11. The bait drive unit (1) as recited in one of the preceding claims 4, characterized in that at least the energy storage device (2) and the electromotive drive device (3) are disposed in the watertight shell (6).

12. The bait drive unit (1) as recited in one of the preceding claims 5, characterized in that at least the energy storage device (2) and the electromotive drive device (3) are disposed in the watertight shell (6).

13. The bait drive unit (1) as recited in one of the preceding claims 6, characterized in that at least the energy storage device (2) and the electromotive drive device (3) are disposed in the watertight shell (6).

14. The bait drive unit (1) as recited in one of the preceding claims 7, characterized in that at least the energy storage device (2) and the electromotive drive device (3) are disposed in the watertight shell (6).

15. A bait fish (100) comprising a bait drive unit (1) as recited in one of the preceding claims 1, characterized in that the electromotive drive device (3) is mounted in a rotatably fixed manner in the body (101) of the bait fish (100) and in that the body (101) of the bait fish (100), at least in a region in which the actuatable shaft (4) is guided by the electromotive drive device (3) in the bait fish (100), is made from an elastic material, wherein the elastic material has a greater bending elasticity than the shaft (4), and the actuatable shaft (4) is guided in the bait fish (100) in such a manner that a movement of the shaft (4) guided in the bait fish (100) is transferred to the elastic material.

10. The bait fish (110) comprising a bait drive unit (1) as recited in one of the preceding claims 1, characterized in that the electromotive drive device (3) is mounted in a rotatably fixed manner in the body (111) of the bait fish (110) and in that the body (111) of the bait fish (110), at least in the region in which the actuatable shaft (4) is guided by the electromotive drive device (3) in the bait fish (110), is made from an elastic material, wherein the elastic material has a greater bending elasticity than the shaft (4), and the actuatable shaft (4) is guided in the bait fish (110) in such a manner that a movement of the shaft (4) guided in the bait fish (110) is transferred to the elastic material, and the shaft (4) in the region of the curvature has a molding (7) and the elastic body has a recess (108) for the molding.
